(19) United States
(12) Patent Application Publication
(10) Pub. No.: US 2009/0326317 A1
(43) Pub. Date: Dec. 31, 2009

(54) Instrument for intra-uterine transfer via the natural vagino-uterine route

(75) Inventors: Laurent HUET, Soligny La Trappe (FR); Christophe STAUB, Les Genettes (FR)

Correspondence Address: BROWDY AND NEIMARK, P.L.L.C.;624 NINTH STREET, NW, SUITE 300, WASHINGTON, DC, 20001-5303, US

(73) Assignee: IMV TECHNOLOGIES, L'AIGLE (FR)

(21) Appl. No.: 12/495,266

(22) Filed: Jun. 30, 2009

(30) Foreign Application Priority Data
Jun. 30, 2008 (FR) 0854421

(51) Int. Cl. A61D 19/02

(52) U.S. Cl. 600/35

(57) ABSTRACT

Instrument for intra-uterine transfer by the natural vagino-uterine route, including a catheter (6) including a tube carrying at one end a transfer head (8), said tube having passing through it a passage for feeding substances, said transfer head (8) being provided with at least one orifice for substances to be transferred to pass through; characterized in that said transfer head (8) has an oblong shape having a general orientation in line with that of said tube, with a varying cross section including at least two separate rounded lateral enlargements (31, 32), no portion of said head (8) being more prominent laterally than said two enlargements (31, 32).

The invention relates to instruments for intra-uterine transfer via the natural vagino-uterine route.

There are already known, notably from the published patent applications EP 0 189 702 and WO 03/065925, instruments for inseminating or for transferring embryos into the uterus of a female animal such as a sow. These instruments generally include a device of the probe type intended to be introduced into the vagina of the animal. This probe carries at its end a tip that is adapted to be positioned in the region of the cervix of the uterus, either pressing on the latter or partially extending through it in a fixed position relative to it, to serve as a longitudinal point of reference for the insemination device. In both cases this tip closes the cervix and prevents backflow of the products that will be injected into the inside of the uterus. This probe generally encloses a flexible catheter intended to pass through said tip to be deployed in the uterus after the positioning of the tip and to enable injection of the products as close as possible to the required area, that is to say as close as possible to the uterine horns. The catheter remains enclosed in the probe during the introduction of the latter into the vagina in order to keep it clean and to prevent it from being polluted by contact with the vaginal wall. The length of the catheter that the operator deploys from the probe is furthermore predetermined, thanks to marks carried by the probe, which are graduated as a function of the age of the animal or the number of farrows that it has already had.

The invention aims to provide a catheter the end of which can enter and advance optimally in a uterine horn.

To this end, the invention proposes an instrument for intra-uterine transfer by the natural vagino-uterine route, including a catheter including a tube carrying at one end a transfer head, said tube having passing through it a passage for feeding substances, said transfer head being provided with at least one orifice for substances to be transferred to pass through; characterized in that said transfer head has an oblong shape having a general orientation in line with that of said tube, with a varying cross section including at least two separate rounded lateral enlargements, no portion of said head being more prominent laterally than said two enlargements.

The oblong character of the transfer head, i.e. the fact that it is longer than it is wide, whereas the greatest width is of course less than and relatively close to the diameter of a uterine horn, prevents, on advance of the head into a horn, it taking up a transverse position or being turned back on itself, which is absolutely to be avoided, because in such a case the outlet orifice or the passage conveying the substance to be transferred will be blocked and/or the catheter will no longer be able to advance.

Moreover, the fact that no portion of the transfer head is more prominent laterally than the two rounded enlargements offers the advantage that the area of contact of the head with the uterine horns is limited to lines, one for each enlargement, which greatly facilitates sliding of the transfer head.

According to features preferred because of the quality of the results obtained and the convenience of fabrication and use:

the two enlargements have equal sections;

the transfer head has symmetry of revolution about its axis;

the greatest length of the transfer head is at least twice the greatest diameter of the enlargements;

the greatest length of the transfer head is substantially three times the greatest diameter of the enlargements;

the greatest length of the transfer head is between 20 and 40 mm inclusive;

the greatest length of the transfer head is substantially equal to 30 mm;

the section of a constriction separating said two enlargements is between one quarter and one half inclusive of the greatest section of the enlargements;

at least one of the ends of said transfer head has a rounded shape;

the two ends of said transfer head have a rounded shape;

the transfer head is symmetrical with respect to a plane perpendicular to its axis and passing through a diameter of a constriction separating said two enlargements; and/or

the transfer head is made from polyoxymethylene.

According to other preferred features relating to the production of the catheter, the latter includes a tube pierced by said passage and by a second passage separate from and parallel to the first, said second passage containing a reinforcing cable.

This is a particularly simple, convenient and economical way to impart to the catheter both the flexibility and the resistance to bending that enable it to move under the optimum conditions in the uterus and then in a uterine horn.

To facilitate tracking the advance of the catheter by ultrasound scanning, said reinforcing cable is preferably made from a material adapted to backscatter ultrasound.

Generally speaking, given the quality of the results obtained, it is beneficial if said reinforcing cable has a diameter between 1 and 1.5 mm inclusive.

It will be noted that the features of the catheter that have just been described, which involve a reinforcing cable, can be used in catheters associated with a transfer head other than that described hereinabove, or even used otherwise than in the transfer instrument referred to above.

According to other features preferred for their simplicity and their convenience of use, whilst being particularly reliable:

the transfer head is glued to the tube;

the transfer head is fixed to the tube by gluing and by a peg inserted on the one hand in the end of the second passage and on the other hand in an appropriate housing carried by said transfer head;

said peg is a notched peg;

the transfer head is fixed to the tube by gluing and by a pin penetrating both the catheter and the transfer head along an axis perpendicular to its axis;

the end of the tube carrying the transfer head is extended by an additional duct of smaller diameter through which only the passage passes;

the transfer head includes a through-cavity receiving said additional duct; and/or

the additional duct extends in said through-cavity until it discharges at the end of said transfer head.

According to other features preferred for their convenience in use, the instrument further includes a probe provided at one of its ends with a tip adapted to be positioned against or in the cervix of the uterus, said catheter being inserted in the central space of the probe and being adapted to pass through said tip from a retracted position in which the transfer head of the catheter is retracted inside the central space of said probe to a deployed position in which said transfer head projects out of the tip of the probe.

The description of the invention will now continue with the description of a preferred embodiment given hereinafter by way of nonlimiting illustration and with reference to the appended drawings. In the latter:

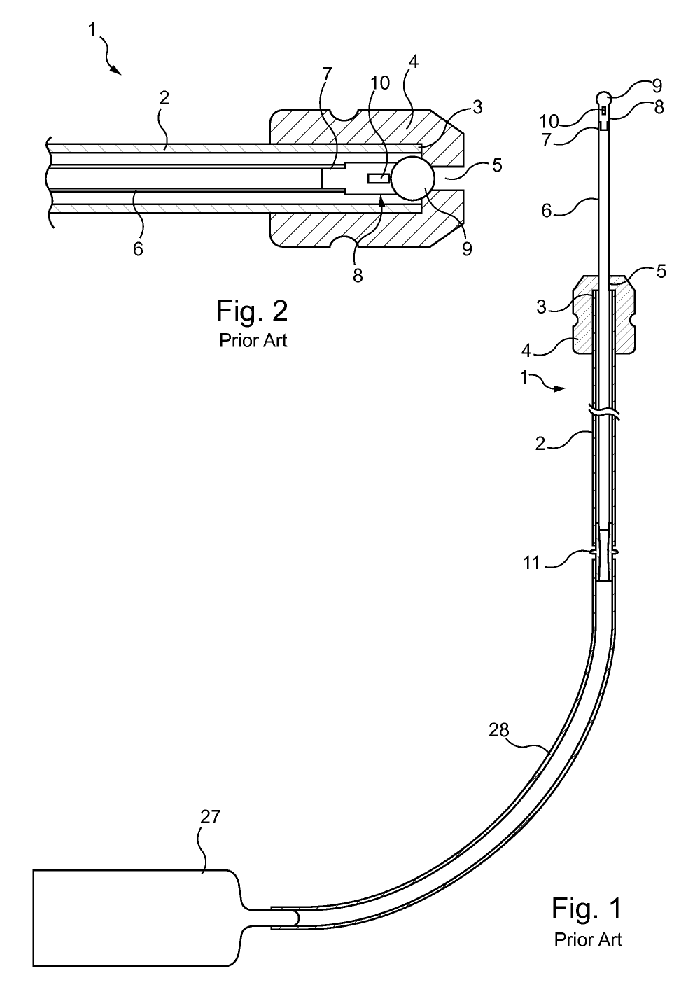

FIG. 1 is a view in section of a prior art intra-uterine transfer instrument;

FIG. 2 is a detail view in section of this instrument, showing more particularly the tip of the probe and the terminal portion of the catheter in the position retracted into the probe;

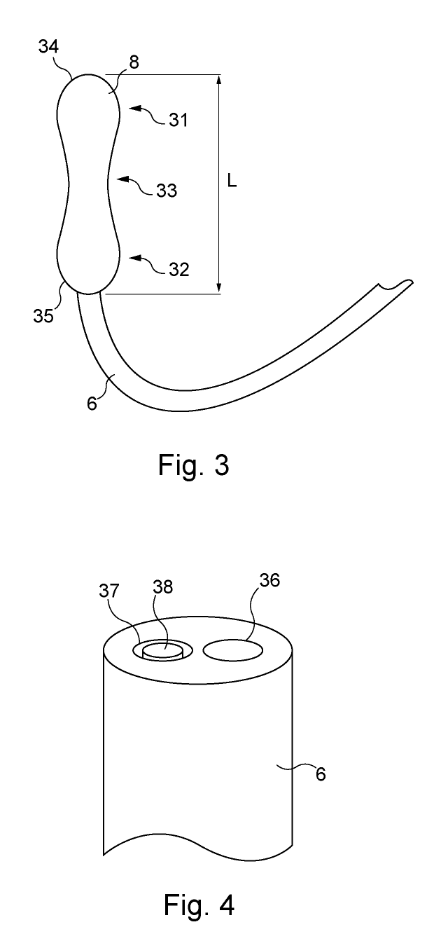

FIG. 3 is a diagrammatic view of the terminal portion of a catheter of the invention;

FIG. 4 is a perspective view of the distal end of the tube of a catheter of the invention before mounting its transfer head;

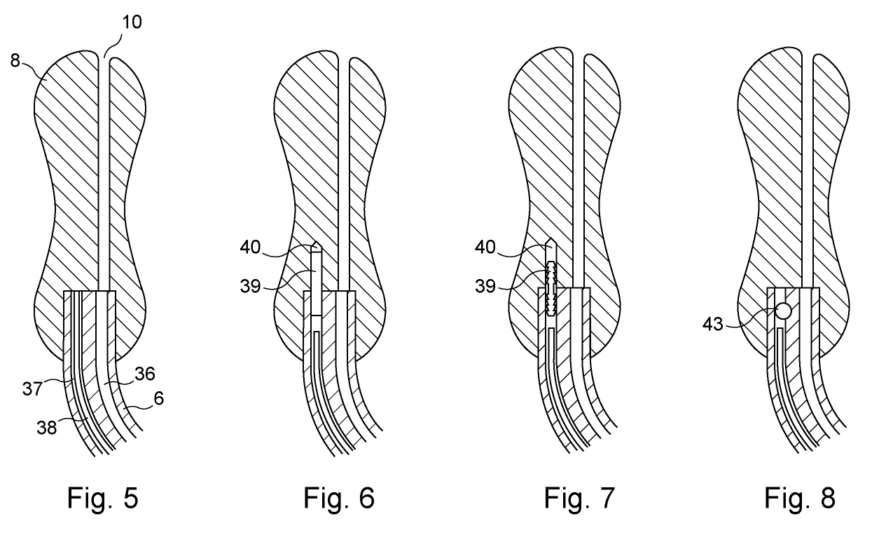

FIG. 5 is a view in section of the terminal portion of the catheter;

FIGS. 6 to 8 are views similar to FIG. 5 for variants of the catheter; and

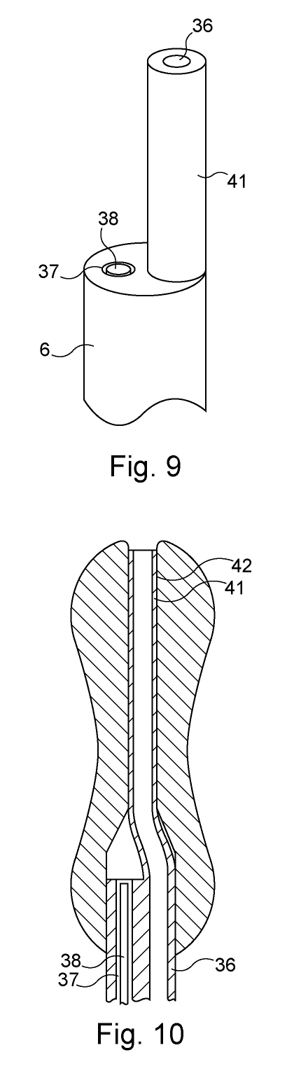

FIGS. 9 and 10 are views similar to FIGS. 4 and 5 for another variant of the catheter.

FIG. 1 shows a prior art intra-uterine transfer instrument connected to means 27 for supplying substances to be transferred and to a connecting pipe 28 via a connector 11.

The instrument proper includes a probe 1 that is provided at one of its ends with a tip 4. The probe 1 is adapted to be inserted via the natural vagino-uterine route into or against the uterus of a female animal, such as a sow or a wild sow, that is to be impregnated by artificial insemination, for example. The probe 1 includes a hollow tube 2 that carries a tip 4 at its distal end, i.e. that opposite the supply means 27. This tip 4 is substantially cylindrical with the distal end chamfered to prevent injury on its introduction and to facilitate its passing through the cervix of the uterus. Its middle portion features a circular groove so as to be held in position by straddling the cervix and thereby to define a longitudinal reference point for the uterine cavity.

The probe 1 also includes, inserted inside the hollow tube 2, a catheter 6 adapted to slide between a retracted position in which it is positioned entirely within the central space of the tube 2 and a deployed position in which it projects out of the tube 2, through the tip 4, to reach the back of the uterine cavity and deposit the substances to be transferred in the immediate vicinity of the uterine horns. This catheter has at its distal end 7 a transfer head 8 provided with a ball-shaped terminal portion 9 carrying an orifice 10 for evacuation of the substances to be transferred.

Referring to FIG. 2, the catheter 6 is seen in the retracted position, with its terminal portion 9 bearing against the inside wall of the distal end of the tip 4. This tip features an orifice 5 through which the catheter and its transfer head pass, subject to elastic deformation, to project into the uterine cavity.

Referring now to FIG. 3, there is seen a catheter whose transfer head 8 is peanut-shaped, i.e. of oblong shape, here with two enlargements, a distal enlargement 31 and a proximal enlargement 32, separated by a constriction 33 of smaller section. The two enlargements represented have equal sections, without this feature being imperative. The head 8 is oriented in line with the tube of the catheter 6 in order to impart longitudinal stability to the head when it is pushed by the tube inside the uterine horns. This oblong shape prevents the terminal portion turning back on itself and taking up a transverse position relative to the required direction of advance.

To guarantee this longitudinal stability, the greatest length L is preferably more than twice the greatest diameter of the enlargements 31 and 32, and even more preferably equal to three times that diameter. In the case of an intra-uterine transfer instrument intended for the pig family, this length L is between 20 and 40 mm inclusive and preferably of the order of 30 mm.

The second advantage of this peanut shape stems from the presence of the two enlargements 31 and 32 that have only a circular line of contact with a cylinder that would form a tangential envelope for the head 8. This means that the areas of contact with the inside wall of the uterine horns on introduction of the catheter consist of only two lines, one for each enlargement. Sliding of the transfer head is therefore greatly facilitated and the comfort of the animal improved accordingly.

The section of the constriction is preferably between one quarter and one half inclusive of the greatest section of the enlargements 31 and 32 and even more preferably substantially equal to one third of that largest section.

The peanut shape of the head 8 has two rounded ends, a distal rounded end 34 and a proximal rounded end 35. The object of the distal rounded end 34 is firstly to facilitate passage of the head 8 through the orifice 5 of the tip 4 and then its introduction into the uterus of the animal, preventing it digging into the wall of the uterus and causing the animal unnecessary suffering. The proximal rounded shape can be a section of a sphere, as indicated in FIG. 3, or any other shape merging with the distal end of the catheter, provided that it has no edges that could injure the animal on withdrawing the probe.

As represented in FIG. 3, without this shape being imperative, the terminal portion exhibits symmetry of revolution about its axis and symmetry relative to a plane perpendicular to that axis passing through a diameter of the constriction 33.

The material used to produce this terminal portion is preferably polyoxymethylene, which has the advantages of lightness and of being smooth, which procures a low coefficient of friction with the uterine wall.

Referring now to FIG. 4, there is seen, represented in section, the distal end of the tube of the catheter, to which the head 8 will be fixed. This tube, which is made of a flexible and smooth material such as low-density polyethylene, has two parallel passages passing longitudinally through it, a first passage 36 for conveying the substances to be transferred and a second passage 37 adapted to receive a reinforcing cable 38.

This second passage extends parallel to the first passage over at least the entire length of the catheter 6. To prevent this tube bending or balling when it is no longer guided by the tube 2, the second passage is provided with a reinforcing cable 38 that gives it an appropriate stiffness for advancing inside the uterus and the uterine horns. This reinforcing cable is preferably made from a material adapted to backscatter ultrasound, which means that, if necessary, its route inside the uterus can be viewed and the place at which the substances will be deposited can be seen by ultrasound scanning.

The size of the reinforcing cable is typically between 1 and 1.5 mm inclusive, and preferably equal to 1.2 mm, for a tube the diameter of which is of the order of 3.5 mm. The diameter of the second passage is then of the order of 1.3 mm.

The distal end of the tube of the catheter 6 is adapted to receive the head 8 which, for this purpose, has at its proximal end a cavity adapted to the male shape of the tube. The distal end of the tube is generally glued into the cavity of the head 8, as represented in FIG. 5. Complementary connecting modes may be combined with gluing in order to guarantee good fixing of the head 8 and to prevent the latter from being detached from the tube and remaining in the uterine cavity on withdrawing the probe.

Variants relating to the fixing of the head 8 are represented in FIGS. 6 to 8. In the variant illustrated in FIG. 6, the reinforcing cable 38 does not extend to the distal end of the tube, so as to leave a free space in the second passage 37 into which can be slipped a peg 39 connecting it to the head 8. For this purpose the head has a complementary passage 40 positioned so that it is in front of the second passage 37 of the tube when the latter is inserted into the cavity of the head 8. The peg 39 is positioned with one end in each of the second passage 37 of the tube and the complementary passage 40 of the head 8 and is retained, for example glued, in place. In the variant illustrated in FIG. 7, the connecting peg 39 has detents and is forced into the second passage 37 and into the complementary passage 40.

Referring to FIG. 8 there is seen another variant in which the assembly of the two parts is made secure by inserting a pin 43 which penetrates both the tube and the head 8 along an axis perpendicular to the axis of said tube.

Finally, referring to FIGS. 9 and 10, there is seen another variant in which the distal end of the tube of the catheter 6 is extended beyond that of the second passage 38 by an additional duct 41, of smaller diameter than the tube and through which only the first passage 36 passes. In parallel fashion the head 8 has a cavity 42 passing through it the diameter of which corresponds to that of the additional duct 41. The additional duct 41 can thus be inserted into this through-cavity 42 and retained, for example glued, therein. The length of the additional duct 41 is preferably equal to that of the through-cavity 42, so that the outlet orifice 10 of the tube is level with the distal portion of the head 8.

This embodiment offers the advantage of offering a large gluing area between the catheter and the head and thus of guaranteeing good fastening together of the two parts.

In variants that are not shown, the additional duct 41 is not in one piece with the remainder of the tube of the catheter 6 but formed by an attached part, for example a part that is glued on, welded on or force-fitted.

In another variant that is not shown, the coupling between the tube of the catheter and the head 8 is effected by molding the material of the head over the tube.

In another variant that is not shown, the transfer passage of the head 8 does not discharge through an orifice 10 at the distal end 34, but through one or more orifices disposed differently, for example two lateral orifices as in the prior art device shown in FIG. 2.

In another variant that is not shown, the transfer head 8 includes more than two enlargements like the enlargements 31 and 32, for example three enlargements with two adjoining enlargements that are separated from each other by a constriction like the constriction 33.

The catheter 6 shown in FIGS. 4 to 10 and described hereinabove is particularly suitable for non-surgical embryo transfer, but is also suitable for other applications in the field of artificial insemination, in particular deep insemination, or for transferring substances for purposes other than artificial insemination, for example medications.

It is beneficial to use the catheter 6 in an intra-uterine transfer instrument such as the device 1 shown in FIGS. 1 and 2 but it should be noted that, because of the resistance to bending imparted to it by the presence of the cable 38, the catheter 6 is in certain circumstances usable directly as an intra-uterine transfer instrument, or can be used with a different applicator device, for example a sheath in the shape of a finger stall having substantially the length of the vaginal cavity and the end of which is torn by the head 8 when the sheath encounters the cervix of the uterus.

Numerous other variants are possible as a function of circumstances, and in this respect it is pointed out that the invention is not limited to the examples described and shown.

1. Instrument for intra-uterine transfer by the natural vagino-uterine route, including a catheter (6) including a tube carrying at one end a transfer head (8), said tube having passing through it a passage (36) for feeding substances, said transfer head (8) being provided with at least one orifice (10) for substances to be transferred to pass through; characterized in that said transfer head (8) has an oblong shape having a general orientation in line with that of said tube, with a varying cross section including at least two separate rounded lateral enlargements (31, 32), no portion of said head (8) being more prominent laterally than said two enlargements (31, 32).

2. Transfer instrument according to claim 1, wherein the two enlargements (31, 32) have equal sections.

3. Transfer instrument according to claim 1, wherein the transfer head has symmetry of revolution about its axis.

4. Transfer instrument according to claim 1, wherein the greatest length (L) of the transfer head is at least twice the greatest diameter of the enlargements (31, 32).

5. Transfer instrument according to claim 4, wherein the greatest length (L) of the transfer head (8) is substantially three times the greatest diameter of the enlargements (31, 32).

6. Transfer instrument according to claim 1, wherein the greatest length of the transfer head (8) is between 20 and 40 mm inclusive.

7. Transfer instrument according to claim 6, wherein the greatest length of the transfer head (8) is substantially equal to 30 mm.

8. Transfer instrument according to claim 1, wherein the section of a constriction (33) separating said two enlargements (33, 34) is between one quarter and one half inclusive of the greatest section of the enlargements (31, 32).

9. Transfer instrument according to claim 1, wherein at least one of the ends (34, 35) of said transfer head (8) has a rounded shape.

10. Transfer instrument according to claim 9, wherein the two ends (34, 35) of said transfer head (8) have a rounded shape.

11. Transfer instrument according to claim 1, wherein the transfer head (8) is symmetrical with respect to a plane perpendicular to its axis and passing through a diameter of a constriction (33) separating said two enlargements (31, 32).

12. Transfer instrument according to claim 10, wherein the transfer head is made from polyoxymethylene.

13. Transfer instrument according to claim 1, characterized in that the catheter (6) includes a tube, pierced by said passage (36) and by a second passage (37) separate from and parallel to the first, said second passage containing a reinforcing cable (38).

14. Transfer instrument according to claim 13, wherein said reinforcing cable (38) is made from a material adapted to backscatter ultrasound.

15. Transfer instrument according to claim 13, wherein said reinforcing cable (38) has a diameter between 1 and 1.5 mm inclusive.

16. Transfer instrument according to claim 1, wherein the transfer head (8) is glued to the tube.

17. Transfer instrument according to claim 16, wherein the transfer head (8) is fixed to the tube by gluing and by a peg (39) inserted on the one hand in the end of the second passage (37) and on the other hand in an appropriate housing (40) carried by said transfer head (8).

18. Transfer instrument according to claim 17, wherein said peg (39) is a notched peg.

19. Transfer instrument according to claim 16, wherein the transfer head (8) is fixed to the tube by gluing and by a pin (43) penetrating both the catheter (6) and the transfer head (8) along an axis perpendicular to its axis.

20. Transfer instrument according to claim 1, wherein the end of the tube carrying the transfer head (8) is extended by an additional duct (41) of smaller diameter through which only the passage (36) passes.

21. Transfer instrument according to claim 20, wherein the transfer head (8) includes a through-cavity (42) receiving said additional duct (41).

22. Transfer instrument according to claim 21, wherein the additional duct (41) extends in said through-cavity (42) until it discharges at the end of said transfer head (8).

23. Transfer instrument according to claim 1, including, in addition to said catheter (6), a probe (1) provided at one of its ends with a tip (4) adapted to be positioned against or in the cervix of the uterus, said catheter (6) being inserted in the central space of the probe (1) and being adapted to pass through said tip (4) from a retracted position in which the transfer head (8) of the catheter (6) is retracted inside the central space of said probe to a deployed position in which said transfer head (8) projects out of the tip (4) of the probe (1).
